(19) United States
(12) Patent Application Publication
(10) Pub. No.: US 2025/0358007 A1
(43) Pub. Date: Nov. 20, 2025

(54) OPTICAL COMMUNICATION APPARATUS, OPTICAL COMMUNICATION METHOD, AND OPTICAL COMMUNICATION PROGRAM

(71) Applicant: KYOCERA Corporation, Kyoto-shi, Kyoto (JP)

(72) Inventors: Chiharu YAMAZAKI, Ota-ku, Tokyo (JP); Atsuhisa INAKOSHI, Yamato-shi, Kanagawa (JP)

(21) Appl. No.: 18/869,733

(22) PCT Filed: May 15, 2023
(86) PCT No.: PCT/JP2023/018096

§ 371 Date: Nov. 26, 2024

(30) Foreign Application Priority Data
May 27, 2022 (JP) 2022-086951

(51) Int. Cl. H04B 10/116; H04B 10/079; H04B 10/50

(52) U.S. Cl. CPC H04B 10/116; H04B 10/0795; H04B 10/50

(57) ABSTRACT

A base station apparatus includes a plurality of light emitting elements and a controller configured to divide the plurality of light emitting elements into a plurality of clusters, each of the plurality of clusters being constituted by at least one of the light emitting elements. The controller changes a combination of the at least one of the plurality of light emitting elements constituting each of the plurality of clusters in a time division manner and controls the plurality of light emitting elements and causes the at least one of the plurality of light emitting elements in each of the plurality of clusters to transmit the same light signal in an individual time interval.

### TECHNICAL FIELD

The present disclosure relates to an optical communication apparatus, an optical communication method, and an optical communication program.

### BACKGROUND OF INVENTION

A known optical communication system uses visible light as a transmission medium, for example, in underwater communication (see, for example, Patent Document 1). Visible light has high directivity, and thus, in a known optical communication system, communication is generally performed with a transmission side and a reception side facing each other on the assumption that optical communication apparatuses on the transmission side and the reception side are fixed.

As a technology for using a plurality of light emitting elements of an optical communication apparatus on a transmission side in an optical communication system, a technology for transmitting a reference light signal from each light emitting element in a time division manner is proposed (see Patent Document 2).

### CITATION LIST

### Patent Literature

Patent Document 1: JP 4-103232 A
Patent Document 2: JP 2020-532899 T

### SUMMARY

In a first aspect, an optical communication apparatus includes: a plurality of light emitting elements; and a controller configured to divide the plurality of light emitting elements into a plurality of clusters, each of the plurality of clusters being constituted by at least one of the plurality of light emitting elements. The controller changes a combination of the at least one of the plurality of light emitting elements constituting each of the plurality of clusters in a time division manner and controls the plurality of light emitting elements and causes the at least one light emitting element in each of the plurality of clusters to transmit the same light signal in an individual time interval.

In a second aspect, an optical communication method used in an optical communication apparatus including a plurality of light emitting elements includes the steps of: dividing the plurality of light emitting elements into a plurality of clusters, each of the plurality of clusters being constituted by at least one of the plurality of light emitting elements; changing a combination of the at least one of the plurality of light emitting elements constituting each of the plurality of clusters in a time division manner; and controlling the plurality of light emitting elements and causing the at least one light emitting element in each of the plurality of clusters to transmit the same light signal in an individual time interval.

In a third aspect, an optical communication program causes an optical communication apparatus including a plurality of light emitting elements to perform: dividing the plurality of light emitting elements into a plurality of clusters, each of the plurality of clusters being constituted by at least one of the plurality of light emitting elements; changing a combination of the at least one of the plurality of light emitting elements constituting each of the plurality of clusters in a time division manner; and controlling the plurality of light emitting elements and causing the at least one light emitting element in each of the plurality of clusters to transmit the same light signal in an individual time interval.

### BRIEF DESCRIPTION OF THE DRAWINGS

FIG. 1 is a diagram illustrating a configuration example of an optical communication system according to an embodiment.

FIG. 2 is a diagram illustrating a configuration example of a base station apparatus according to the embodiment.

FIG. 3 is a diagram illustrating an outer appearance configuration example of the base station apparatus according to the embodiment.

FIG. 4 is a diagram illustrating a configuration example of a terminal apparatus according to the embodiment.

FIG. 5 is a diagram illustrating an outer appearance configuration example of the terminal apparatus according to the embodiment.

FIG. 6 is a diagram illustrating an example of combined transmission according to the embodiment.

FIG. 7 is a diagram illustrating an example of the combined transmission according to the embodiment.

FIG. 8 is a diagram illustrating an example of the combined transmission according to the embodiment.

FIG. 9 is a diagram illustrating an operation example of the base station apparatus according to the embodiment.

FIG. 10 is a diagram illustrating an operation example of the base station apparatus according to the embodiment.

FIG. 11 is a diagram illustrating an operation example of the base station apparatus according to the embodiment.

FIG. 12 is a diagram illustrating an example of a communication sequence of the optical communication system according to the embodiment.

FIG. 13 is a diagram illustrating a first configuration example of a communication frame according to the embodiment.

FIG. 14 is a diagram illustrating a second configuration example of the communication frame according to the embodiment.

FIG. 15 is a diagram illustrating a third configuration example of the communication frame according to the embodiment.

FIG. 16 is a diagram illustrating a fourth configuration example of the communication frame according to the embodiment.

FIG. 17 is a diagram illustrating a fifth configuration example of the communication frame according to the embodiment.

FIG. 18 is a diagram for describing another embodiment.

FIG. 19 is a diagram for describing another embodiment.

FIG. 20 is a diagram for describing another embodiment.

FIG. 21 is a diagram for describing another embodiment.

FIG. 22 is a diagram for describing another embodiment.

### DESCRIPTION OF EMBODIMENTS

In visible light communication, combined transmission is effective in which the same light signals are transmitted from a plurality of light emitting elements. In the combined transmission, the light signals transmitted by the plurality of light emitting elements are combined and thus, for example, an effect of extending a communicable distance can be obtained. However, there is room for improvement in an optical communication system that performs the combined transmission in terms of improving the communication capacity (that is, system capacity) of the optical communication system.

The present disclosure provides an improvement of the communication capacity of an optical communication system using combined transmission.

An optical communication system according to an embodiment will be described with reference to the drawings. In the description of the drawings, the same or similar parts are denoted by the same or similar reference signs.

The optical communication system according to the embodiment is a system that performs visible light communication. The optical communication system according to the embodiment is a system that performs underwater light communication. However, the optical communication system is not limited to a system that performs underwater light communication, and may be a system that performs light communication on the ground (or in space).

### (1) Configuration Example of Optical Communication System

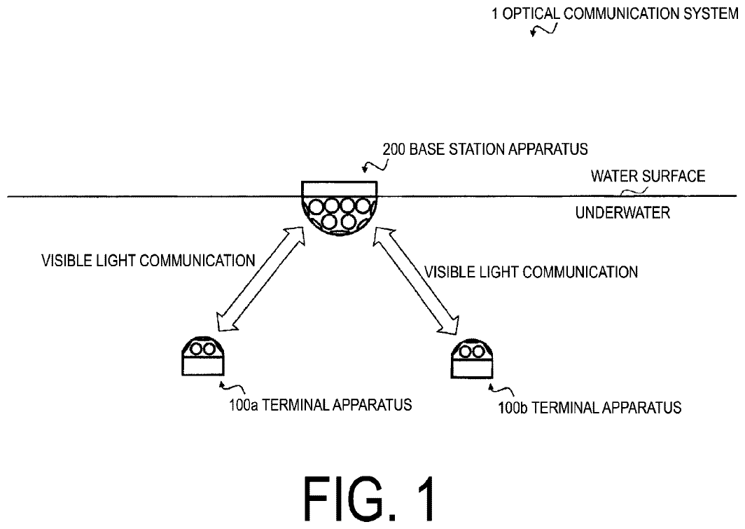

First, a configuration example of the optical communication system according to the embodiment will be described. FIG. 1 illustrates a configuration example of an optical communication system 1 according to the embodiment.

The optical communication system 1 includes a plurality of terminal apparatuses 100 (100a, 100b) and a base station apparatus 200. However, the number of terminal apparatuses 100 and the number of base station apparatuses 200 are not limited to those in the example of FIG. 1.

The base station apparatus 200 is an example of an optical communication apparatus. In the example of FIG. 1, the base station apparatus 200 is at a water surface. For example, the base station apparatus 200 is fixed to a buoy. The base station apparatus 200 is connected to a network via a backhaul line. The backhaul line may be a wireless or wired line. In order to efficiently secure a communication area underwater, the base station apparatus 200 may be installed at a predetermined distance from other adjacent base station apparatuses. For example, the base station apparatus 200 may be temporarily installed during a period in which an underwater investigation using the terminal apparatuses 100 is performed.

Each terminal apparatus 100 is another example of an optical communication apparatus. Each terminal apparatus 100 is underwater. Each terminal apparatus 100 is configured to be movable underwater. Each terminal apparatus 100 performs visible light communication (specifically, underwater visible light communication) with the base station apparatus 200. That is, the base station apparatus 200 is a serving base station for each terminal apparatus 100.

Each terminal apparatus 100 may include a sensor such as an image sensor and generate sensor data. For example, each terminal apparatus 100 may transmit uplink (UL) data including the sensor data to the base station apparatus 200 through visible light communication. Each terminal apparatus 100 may receive downlink (DL) data including instruction data from the base station apparatus 200 through visible light communication. Each terminal apparatus 100 may move and perform a sensing operation (imaging or the like) based on the instruction data.

In the embodiment, the base station apparatus 200 performs combined transmission in which the same light signals are transmitted from a plurality of light emitting elements in a downlink. In the combined transmission, the light signals transmitted by the plurality of light emitting elements are combined and thus, for example, an effect of extending a communicable distance can be obtained. Combined transmission in a downlink will mainly be described below. However, each terminal apparatus 100 may perform combined transmission in an uplink.

In the example of FIG. 1, the base station apparatus 200 accommodates the two terminal apparatuses 100. Increasing the number of terminal apparatuses 100 accommodated by the base station apparatus 200 can improve the system capacity of the optical communication system 1. The base station apparatus 200 needs to follow the movement of each terminal apparatus 100. The base station apparatus 200 selects a combination of at least one light emitting element to be used for combined transmission in accordance with the situation of each terminal apparatus 100.

### (2) Configuration Example of Base Station Apparatus

Next, a configuration example of the base station apparatus 200 according to the embodiment will be described.

### (2.1) Block Configuration Example of Base Station Apparatus

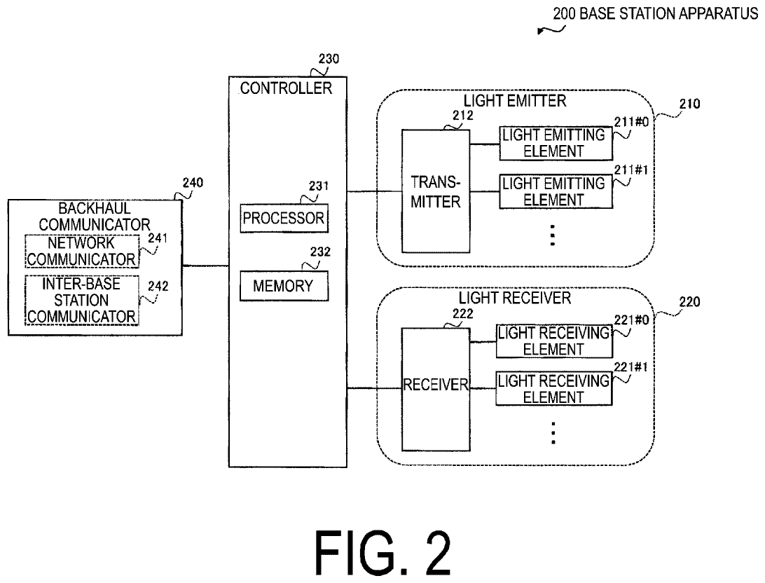

FIG. 2 is a diagram illustrating the configuration example of the base station apparatus 200 according to the embodiment. The base station apparatus 200 includes a light emitter 210, a light receiver 220, a controller 230, and a backhaul communicator 240. The base station apparatus 200 may include a battery for supplying electrical power necessary for the base station apparatus 200 to operate.

The light emitter 210 transmits a light signal to each terminal apparatus 100 under control of the controller 230. The light emitter 210 includes a plurality of light emitting elements 211 (211 #0, 211 #1, . . . ) and a transmitter 212.

Each light emitting element 211 may be a laser diode or a light emitting diode. Each light emitting element 211 converts an electrical signal (transmission signal) output by the transmitter 212 for visible light communication into a light signal and transmits the light signal.

The transmitter 212 may be made of a Field-Programmable Gate Array (FPGA) and/or a System on a Chip (SoC). The transmitter 212 performs signal processing on a transmission signal output from the controller 230, converts the signal after the signal processing, and outputs the signal to each light emitting element 211. In the embodiment, the directions of the optical axes of the plurality of light emitting elements 211 are different from each other. That is, the plurality of light emitting elements 211 have directivity (transmission directivity) in different directions.

The light receiver 220 receives a light signal from the terminal apparatus 100. The light receiver 220 includes a plurality of light receiving elements 221 (221 #0, 221 #1, . . . ) and a receiver 222.

Each light receiving element 221 may be a photodiode. Each light receiving element 221 receives a light signal, converts the received light signal into an electrical signal (reception signal), and outputs the reception signal to the receiver 222.

The receiver 222 may be made of an FPGA and/or an SoC. At least a part of the receiver 222 may be integrated with the transmitter 212. The receiver 222 converts the reception signal output by each light receiving element 221, performs signal processing on the converted reception signal, and outputs the processed reception signal to the controller 230.

In the embodiment, the light receiving elements 221 are provided so as to correspond one-to-one to the light emitting elements 211. Specifically, each light receiving element 221 has directivity (reception directivity) in the same direction as a corresponding light emitting element 211. That is, a plurality of pairs of the light emitting elements 211 and the light receiving elements 221 transmit light signals in different directions and receive light signals from different directions.

The controller 230 controls an overall operation of the base station apparatus 200. For example, the controller 230 controls the light emitter 210 and the light receiver 220. The controller 230 includes at least one processor 231 and at least one memory 232. The memory 232 stores a program to be executed by the processor 231 and information to be used for processing by the processor 231. The processor 231 may include a digital signal processor and a CPU. The digital signal processor performs modulation and demodulation, coding and decoding, and the like on digital signals. The CPU executes the program stored in the memory to thereby perform various types of processing.

The backhaul communicator 240 performs backhaul communication via a backhaul line under control of the controller 230. The backhaul communicator 240 may include a network communicator 241 that performs communication with a network (e.g., a core network), and an inter-base station communicator 242 that performs inter-base station communication with an adjacent base station.

In the base station apparatus 200 configured in this way, the controller 230 divides the plurality of light emitting elements 211 into a plurality of clusters, each of the plurality of clusters being constituted by at least one light emitting element 211. Each cluster is a light emitting element group including at least one light emitting element 211. The controller 230 changes a combination of the at least one light emitting element 211 constituting each cluster in a time division manner. The controller 230 performs control such that the at least one light emitting element 211 in each cluster transmits the same light signal (i.e., combined transmission) in each time interval.

In this way, a configuration is adopted in which the plurality of light emitting elements 211 are divided into a plurality of clusters, and combined transmission is performed for each cluster, which makes it easy to simultaneously perform combined transmission to the plurality of terminal apparatuses 100. Combined transmission can also be easily preformed from the plurality of clusters in various directions. Thus, the number of terminal apparatuses 100 that can be accommodated by the base station apparatus 200 that performs combined transmission can be increased.

Further, the combination of the at least one light emitting element 211 constituting each cluster is changed in a time division manner, and thus the combination of the at least one light emitting element used for combined transmission can be changed according to the situation of each terminal apparatus 100, and the movement of each terminal apparatus 100 can be coped with.

In the embodiment, each time interval for performing combined transmission is a time interval included in a downlink communication period. Hereinafter, the time interval may be referred to as a time slot (or slot), but may also be referred to as a subframe. The controller 230 allocates each cluster to at least one terminal apparatus 100. Accordingly, while the cluster change (that is, change in the combination of the at least one light emitting element 211 constituting each cluster) is performed for each time interval within the downlink communication period, combined transmission can be performed for each time interval.

The light receiver 220 (specifically, the light receiving element 221) may receive a feedback light signal from the terminal apparatus 100. The controller 230 determines, based on the feedback light signal from the terminal apparatus 100, a combination of at least one light emitting element 211 constituting a cluster to be allocated to the terminal apparatus 100. This enables allocation of an appropriate cluster (combination of at least one light emitting element 211) to the terminal apparatus 100. Note that, in resource allocation (scheduling) processing, the controller 230 may determine an allocation pattern that maximizes the system capacity from among all the combination patterns of the light emitting elements 211. The controller 230 may determine the allocation pattern that maximizes the system capacity from among predetermined combination patterns of the light emitting elements 211.

The feedback light signal from the terminal apparatus 100 may include information indicating a combination of at least one light emitting element 211 selected by the terminal apparatus 100. The information may include an identifier of a cluster selected by the terminal apparatus 100 and/or an identifier of each light emitting element 211 selected by the terminal apparatus 100. Thus, an appropriate cluster can be easily allocated to each terminal apparatus 100.

The controller 230 may multiplex a plurality of terminal apparatuses 100 to which the same cluster is allocated within one time interval through code division multiple access (CDMA). Thus, the same cluster can be allocated to the plurality of terminal apparatuses 100 within the one time interval, which makes it easy to increase the number of terminal apparatuses 100 that can be accommodated by the base station apparatus 200. When a light signal is multiplexed through CDMA, the controller 230 may perform spreading processing on the light signal addressed to the terminal apparatus 100 using a code (spreading code) assigned to the terminal apparatus 100.

The controller 230 may control the plurality of light emitting elements 211 and cause the at least one light emitting element 211 in each cluster to transmit a reference light signal specific to each cluster (hereinafter referred to as a “cluster-specific reference signal”). The cluster-specific reference signal is a light signal including a different signal sequence for each cluster. The reference light signal is a light signal used for channel estimation and reception power measurement (hereinafter simply referred to as “measurement processing”) in the terminal apparatus 100. The at least one light emitting element 211 in each cluster transmits the cluster-specific reference signal, and thus the terminal apparatus 100 can perform measurement processing on a per-cluster basis.

The feedback light signal received by the light receiver 220 (specifically, the light receiving element 221) from the terminal apparatus 100 includes measurement information on a per-cluster basis obtained by the terminal apparatus 100 performing measurement processing on the cluster-specific reference signal. Thus, the base station apparatus 200 can recognize the reception state in the terminal apparatus 100 on a per-cluster basis based on the feedback light signal. The measurement information may be measurement report information including reference signal reception power and/or reference signal reception quality. The measurement information may be channel state information (CSI).

The controller 230 may control the plurality of light emitting elements 211 to transmit the cluster-specific reference signal of each cluster in a time division manner within one time interval not included in the downlink communication period. As a result, the terminal apparatus 100 can efficiently perform measurement processing on each cluster within the one time interval, which makes it easy to recognize the reception state of each cluster.

The controller 230 may control the plurality of light emitting elements 211 and cause each light emitting element 211 in each cluster to transmit a reference light signal specific to each light emitting element (hereinafter referred to as a “light emitting element-specific reference signal”). The light emitting element-specific reference signal is a light signal including a different signal sequence for each light emitting element 211. When each light emitting element 211 transmits the light emitting element-specific reference signal, the terminal apparatus 100 can perform measurement processing on a per-light emitting element basis.

The feedback light signal received by the light receiver 220 (specifically, the light receiving element 221) from the terminal apparatus 100 may include measurement information on a per-light emitting element basis obtained by the terminal apparatus 100 performing measurement processing on the light emitting element-specific reference signal. The controller 230 may derive the measurement information on a per-cluster basis from the measurement information on a per-light emitting element basis. For example, the controller 230 classifies the measurement information on a per-light emitting element basis into corresponding clusters, and calculates the measurement information on a per-cluster basis from the classified measurement information. Thus, even without using the cluster-specific reference signal, the base station apparatus 200 can recognize the reception state in the terminal apparatus 100 on a per-cluster basis based on the feedback light signal.

The controller 230 may control the plurality of light emitting elements 211 to transmit the cluster-specific reference signal and the light emitting element-specific reference signal in a time division manner within one time interval not included in the downlink communication period. Thus, the terminal apparatus 100 can efficiently perform measurement processing on each cluster and measurement processing on each light emitting element within the one time interval, which makes it easy to recognize the reception state of each cluster and the reception state of each light emitting element.

### (2.2) Outer Appearance Configuration Example of Base Station Apparatus

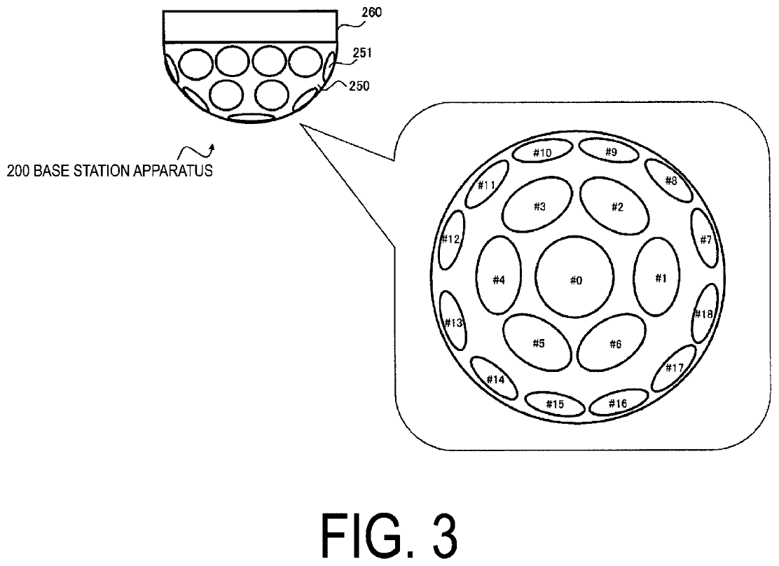

FIG. 3 is a diagram illustrating an outer appearance configuration example of the base station apparatus 200 according to the embodiment.

The base station apparatus 200 includes a hemispherical light receiver/emitter 250 and a body part 260 coupled to the light receiver/emitter 250. However, the base station apparatus 200 may be formed into a spherical shape as a whole. The light receiver/emitter 250 includes a plurality of light receiving/emitting regions 251 arranged in a distributed manner. Each light receiving/emitting region 251 is provided with a pair of a light emitting element 211 and a light receiving element 221. With such a configuration, the base station apparatus 200 can easily perform visible light communication with the terminal apparatuses 100 in various directions.

In the example of FIG. 3, the hemispherical light receiver/emitter 250 includes a total of 19 light receiving/emitting regions 251 including light receiving/emitting regions 251 #0 to 251 #18. That is, the base station apparatus 200 includes a total of 19 light emitting elements including the light emitting elements 211 #0 to 211 #18, and a total of 19 light receiving elements including the light receiving elements 221 #0 to 221 #18.

### (3) Configuration Example of Terminal Apparatus

Next, a configuration example of the terminal apparatus 100 according to the embodiment will be described.

### (3.1) Block Configuration Example of Terminal Apparatus

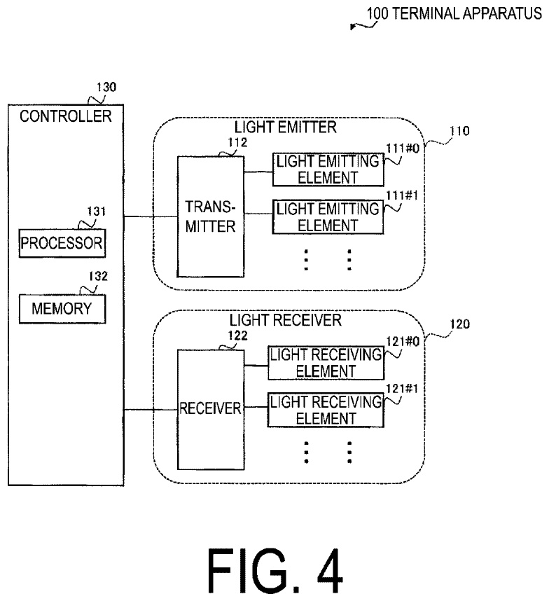

FIG. 4 is a diagram illustrating the configuration example of the terminal apparatus 100 according to the embodiment. The terminal apparatus 100 includes a light emitter 110, a light receiver 120, and a controller 130. The terminal apparatus 100 may include a battery for supplying electrical power necessary for the terminal apparatus 100 to operate. The terminal apparatus 100 may include a moving mechanism (e.g., a motor and a screw) used for the terminal apparatus 100 to move.

The light emitter 110 transmits a light signal to the base station apparatus 200 under control of the controller 130. The light emitter 110 includes a plurality of light emitting elements 111 (111 #0, 111 #1, . . . ) and a transmitter 112.

Each light emitting element 111 may be a laser diode or a light emitting diode. Each light emitting element 111 converts an electrical signal (transmission signal) output by the transmitter 112 for visible light communication into a light signal and transmits the light signal.

The transmitter 112 may be made of an FPGA and/or an SoC. The transmitter 112 performs signal processing on a transmission signal output by the controller 130, converts the signal after the signal processing, and outputs the converted signal to each light emitting element 111. In the embodiment, the directions of the optical axes of the plurality of light emitting elements 111 are different from each other. That is, the plurality of light emitting elements 111 have directivity (transmission directivity) in different directions.

The light receiver 120 receives a light signal from the base station apparatus 200. The light receiver 120 includes a plurality of light receiving elements 121 (121 #0, 121 #1, . . . ) and a receiver 122.

Each light receiving element 121 may be a photodiode. Each light receiving element 121 receives a light signal, converts the received light signal into an electrical signal (reception signal), and outputs the reception signal to the receiver 122.

The receiver 122 may be made of an FPGA and/or an SoC. At least a part of the receiver 122 may be integrated with the transmitter 112. The receiver 122 converts the reception signal output by each light receiving element 121, performs signal processing on the converted reception signal, and outputs the processed reception signal to the controller 130.

In the embodiment, the light receiving elements 121 are provided so as to correspond one-to-one to the light emitting elements 111. Specifically, each light receiving element 121 has directivity (reception directivity) in the same direction as a corresponding light emitting element 111. That is, a plurality of pairs of the light emitting elements 111 and the light receiving elements 121 transmit light signals in different directions and receive light signals from different directions.

The controller 130 controls an overall operation of the terminal apparatus 100. For example, the controller 130 controls the light emitter 110 and the light receiver 120. The controller 130 includes at least one processor 131 and at least one memory 132. The memory 132 stores a program to be executed by the processor 131 and information to be used for processing by the processor 131. The processor 131 may include a digital signal processor and a CPU. The digital signal processor performs modulation and demodulation, coding and decoding, and the like on digital signals. The CPU executes the program stored in the memory to thereby perform various types of processing.

In the terminal apparatus 100 configured in this way, the light receiver 120 (specifically, the light receiving element 121) receives a light signal transmitted through combined transmission from the base station apparatus 200 within a time interval allocated to the terminal apparatus 100. The controller 230 demodulates and decodes the light signal received by the light receiver 120. When the light signal is multiplexed through code division multiplexing, the controller 230 may perform despreading processing on the light signal received by the light receiver 120 using a code (spreading code) assigned to the terminal apparatus 100.

The light receiver 120 (specifically, the light receiving element 121) may receive a cluster-specific reference signal and/or a light emitting element-specific reference signal from the base station apparatus 200. The controller 130 may generate measurement information by performing measurement processing using the cluster-specific reference signal and/or the light emitting element-specific reference signal. The controller 130 may control the light emitter 110 to transmit a feedback light signal including the measurement information to the base station apparatus 200.

The controller 130 may select a combination of at least one light emitting element 211 to be allocated by the base station apparatus 200 to the terminal apparatus 100 based on the result of the measurement processing. The controller 230 may control the light emitter 110 to transmit, to the base station apparatus 200, a feedback light signal including information indicating the selected combination of at least one light emitting element 211.

### (3.2) Outer Appearance Configuration Example of Terminal Apparatus

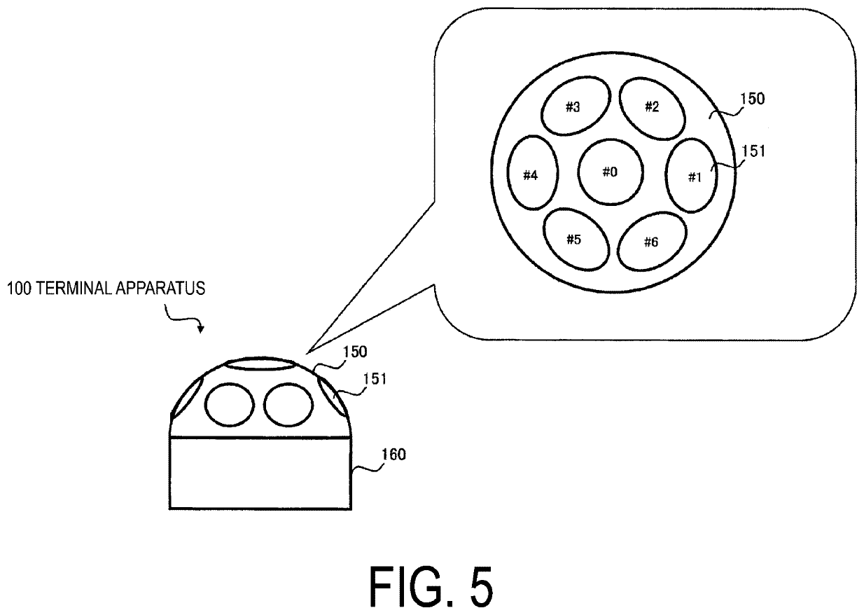

FIG. 5 is a diagram illustrating an outer appearance configuration example of the terminal apparatus 100 according to the embodiment.

The terminal apparatus 100 includes a hemispherical light receiver/emitter 150 and a body part 160 coupled to the light receiver/emitter 150. However, the terminal apparatus 100 may be formed into a spherical shape as a whole. The light receiver/emitter 150 includes a plurality of light receiving/emitting regions 151 arranged in a distributed manner. Each light receiving/emitting region 151 is provided with a pair of a light emitting element 111 and a light receiving element 121. With such a configuration, the terminal apparatus 100 can easily perform visible light communication with base station apparatuses 200 in various directions.

In the example of FIG. 5, the hemispherical light receiver/emitter 150 includes a total of seven light receiving/emitting regions 151 including light receiving/emitting regions 151 #0 to 151 #6. That is, the terminal apparatus 100 includes a total of seven light emitting elements including the light emitting elements 111 #0 to 111 #6, and a total of seven light receiving elements including the light receiving elements 121 #0 to 121 #6.

### (4) Example of Combined Transmission

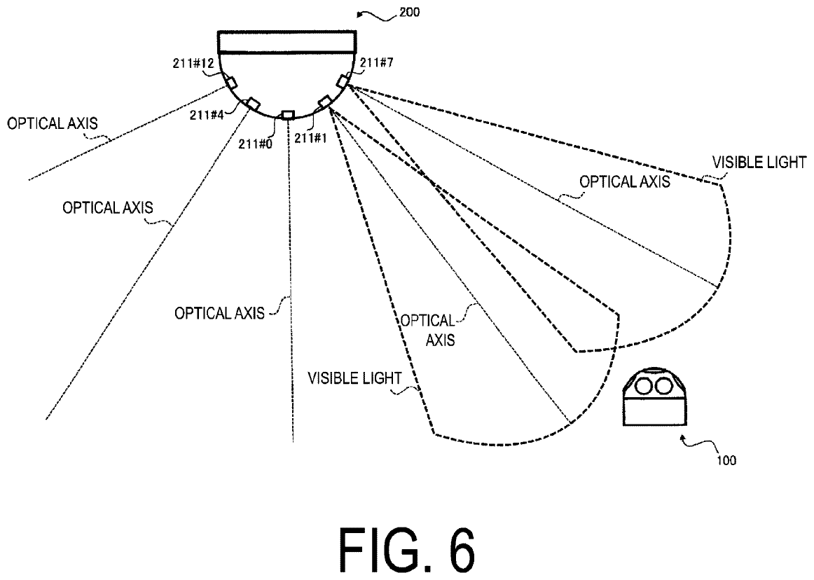

Next, an example of combined transmission according to the embodiment will be described. FIG. 6 is a diagram illustrating the example of the combined transmission according to the embodiment. In the example of FIG. 6, the cross section of the base station apparatus 200 is schematically illustrated.

In the base station apparatus 200, the plurality of light emitting elements 211 are arranged such that the angle formed between the optical axis of one light emitting element 211 and the optical axis of another light emitting element 211 increases as the distance between the one light emitting element 211 and the other light emitting element 211 increases. The angle formed between the optical axis of the light emitting element 211 #0 and the optical axis of the light emitting element 211 #7 not adjacent to the light emitting element 211 #0 is larger than the angle formed between the optical axis of the light emitting element 211 #0 and the optical axis of the light emitting element 211 #1 adjacent to the light emitting element 211 #0.

When one cluster includes at least two light emitting elements 211, the base station apparatus 200 (controller 230) causes the one cluster to be constituted by light emitting elements 211 adjacent to each other. In the example of FIG. 6, the base station apparatus 200 causes a cluster to include the light emitting elements 211 #1 and 211 #7 adjacent to each other, and performs combined transmission from the cluster to the terminal apparatus 100. Visible light emitted by the light emitting element 211 #1 (i.e., light signal transmitted by the light emitting element 211 #1) and visible light emitted by the light emitting element 211 #7 (i.e., light signal transmitted by the light emitting element 211 #7) are the same light signals and are partly combined and intensified underwater. Thus, a communicable distance can be increased.

Here, it is assumed that the number of terminal apparatuses 100 that can be accommodated by the base station apparatus 200 is increased by applying code division multiple access (CDMA) in a downlink. In general, when CDMA is applied only to a downlink, fine transmission power control between terminal apparatuses as in the case of uplink CDMA is unnecessary, and thus it is conceivable that downlink CDMA can be easily achieved. Note that uplink CDMA requires uplink transmission power control in order to equalize the reception powers of light signals received by the base station apparatus 200 from the respective terminal apparatuses 100.

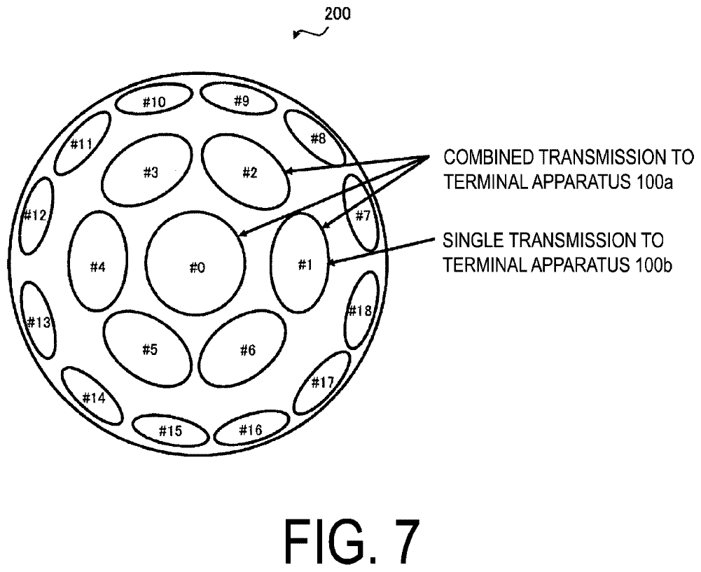

On the premise that downlink CDMA is applied, it is assumed that, as illustrated in FIG. 7, the base station apparatus 200 performs single transmission using a single light emitting element (the light emitting element 211 #1) to the terminal apparatus 100b while performing combined transmission using a plurality of light emitting elements (the light emitting elements 211 #0, #1, and #2) to the terminal apparatus 100a. In this case, since the reception power of the combined transmission is larger than that of the single transmission, there is a large reception power difference between the terminal apparatus 100a and the terminal apparatus 100b, which may cause a trouble in decoding by despreading processing. Specifically, since an interfering wave larger by the amount corresponding to the light emitting elements 211 #0 and #2 than a desired wave enters the terminal apparatus 100b, the desired wave may be buried in the interfering wave.

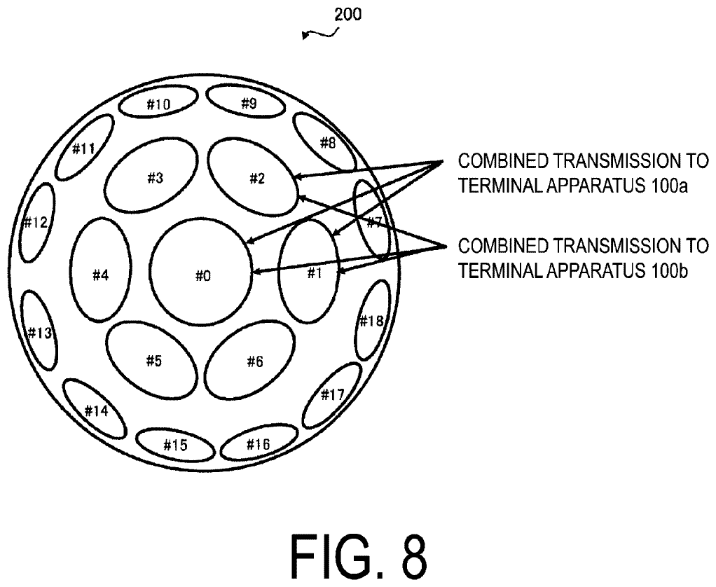

It is conceivable that the above-described problem can be solved when the terminal apparatuses 100a and 100b that have been subjected to code division multiplexing use the same light emitting elements in combined transmission as illustrated in FIG. 8. This however makes it impossible to flexibly combine light emitting elements in response to the movement of each terminal apparatus 100, and thus the system capacity may be reduced. Specifically, the light emitting elements 211 #0 and 2 that could have been allocated to another terminal are used, and thus the system capacity may be reduced. Interference with another terminal to which the adjacent light emitting elements #3, 4, 5, and 6 are allocated increases, and thus the system capacity may be reduced. Furthermore, the degree of freedom in selecting an optimum light emitting element 211 for following the movement of each terminal decreases, and thus the system capacity may be reduced.

In the embodiment, the base station apparatus 200 switches a combination of at least one light emitting element 211 to be used for combined transmission in a time division manner, so that switching of light emitting elements when the terminal apparatus 100 moves is achieved by changing an allocated time slot. Specifically, the base station apparatus 200 according to the embodiment divides the plurality of light emitting elements 211 into a plurality of clusters, each of the plurality of clusters being constituted by at least one light emitting element 211. While changing a combination of the at least one light emitting element 211 constituting each cluster in a time division manner, the base station apparatus 200 transmits the same light signal from the at least one light emitting element 211 in each cluster within each time interval.

Thus, the above-described problem can be solved, and the system capacity can be improved. Note that although the problem when downlink CDMA is applied has been described, downlink CDMA does not need to be applied in the embodiment. The base station apparatus 200 may switch whether or not to apply CDMA in accordance with the traffic situation or the like of the downlink.

### (5) Operation Examples of Base Station Apparatus

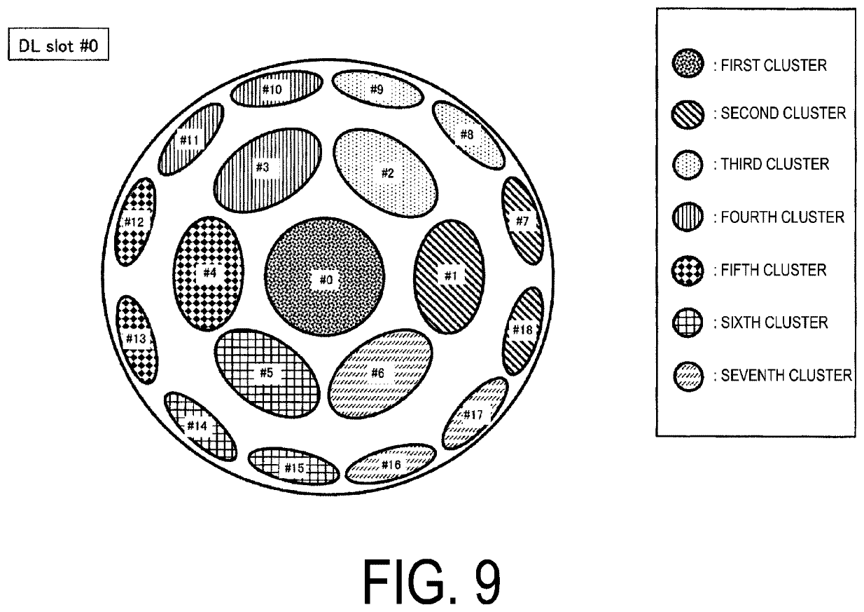

Next, operation examples of the base station apparatus 200 according to the embodiment will be described. FIGS. 9 to 11 are diagrams illustrating operation examples of the base station apparatus 200 according to the embodiment. FIGS. 9 to 11 illustrate respective clusters distinguished by hatching.

As illustrated in FIG. 9, in a downlink time slot (DL slot) #0, the base station apparatus 200 divides the plurality of light emitting elements 211 into a plurality of clusters, each of the plurality of clusters being constituted by at least one light emitting element 211. In the example of FIG. 9, the base station apparatus 200 performs cluster division as follows:
first cluster: one light emitting element 211 #0,
second cluster: three light emitting elements 211 #1, #7, and #18,
third cluster: three light emitting elements 211 #2, #8, and #9,
fourth cluster: three light emitting elements 211 #3, #10, and #11,
fifth cluster: three light emitting elements 211 #4, #12, and #13,
sixth cluster: three light emitting elements 211 #5, #14, and #15, and
seventh cluster: three light emitting elements 211 #6, #17, and #18.

Since each cluster is constituted by the light emitting elements 211 adjacent to each other, the transmission direction of a light signal of each cluster can be made different from the transmission directions of light signals of the other clusters. When one cluster is allocated to one terminal apparatus 100, the base station apparatus 200 can simultaneously perform transmission to seven terminal apparatuses 100 through space division multiple access (SDMA). The base station apparatus 200 can simultaneously perform transmission to more terminal apparatuses 100 using CDMA in combination.

The base station apparatus 200 transmits the same light signals from each of the first to sixth clusters in the DL slot #0. For example, the base station apparatus 200 performs combined transmission in which the same light signals are transmitted from the three light emitting elements 211 #1, #7, and #18 to at least one terminal apparatus 100 allocated to the second cluster. The base station apparatus 200 performs combined transmission in which the same light signals are transmitted from the three light emitting elements 211 #2, #8, and #9 to at least one terminal apparatus 100 allocated to the third cluster. The same also applies to the other clusters.

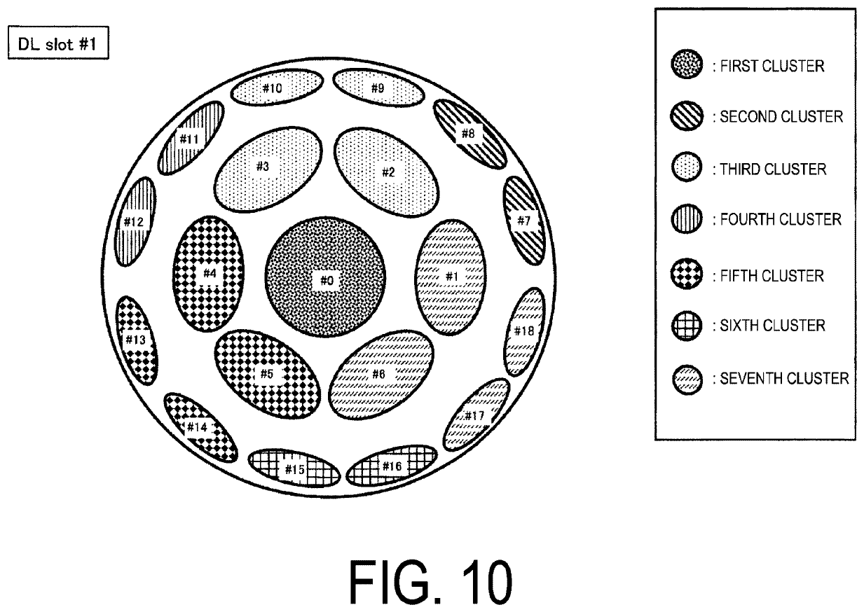

As illustrated in FIG. 10, in a DL slot #1 next to the DL slot #0, the base station apparatus 200 changes the combination of the at least one light emitting element 211 constituting each cluster. In the example of FIG. 10, the base station apparatus 200 performs cluster change as follows:
first cluster: one light emitting element 211 #0,
second cluster: two light emitting elements 211 #7 and #8,
third cluster: four light emitting elements 211 #2, #3, #9, and #10,
fourth cluster: two light emitting elements 211 #11 and #12,
fifth cluster: four light emitting elements 211 #4, #5, #13, and #14,
sixth cluster: two light emitting elements 211 #15 and #16, and
seventh cluster: four light emitting elements 211 #1, #6, #17, and #18.

The base station apparatus 200 transmits the same light signals from each of the first to sixth clusters in the DL slot #1. For example, the base station apparatus 200 performs combined transmission in which the same light signals are transmitted from the two light emitting elements 211 #7 and #18 to at least one terminal apparatus 100 allocated to the second cluster. The base station apparatus 200 performs combined transmission in which the same light signals are transmitted from the four light emitting elements 211 #2, #3, #9, and #10 to at least one terminal apparatus 100 allocated to the third cluster. The same also applies to the other clusters.

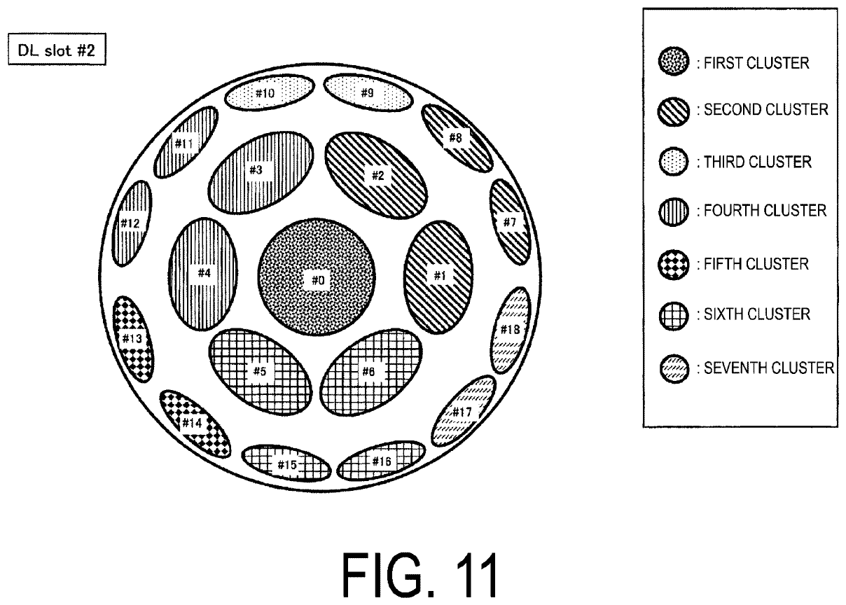

As illustrated in FIG. 11, in a DL slot #2 next to the DL slot #1, the base station apparatus 200 changes the combination of the at least one light emitting element 211 constituting each cluster. In the example of FIG. 11, the base station apparatus 200 performs cluster change as follows:
first cluster: one light emitting element 211 #0,
second cluster: four light emitting elements 211 #1, #2, #7, and #8,
third cluster: two light emitting elements 211 #9 and #10,
fourth cluster: four light emitting elements 211 #3, #4, #11, and #12,
fifth cluster: two light emitting elements 211 #13 and #14,
sixth cluster: four light emitting elements 211 #5, #6, #15, and #16, and
seventh cluster: two light emitting elements 211 #17 and #18.

The base station apparatus 200 transmits the same light signals from each of the first to sixth clusters in the DL slot #1. For example, the base station apparatus 200 performs combined transmission in which the same light signals are transmitted from the two light emitting elements 211 #7 and #18 to at least one terminal apparatus 100 allocated to the second cluster. The base station apparatus 200 performs combined transmission in which the same light signals are transmitted from the four light emitting elements 211 #2, #3, #9, and #10 to at least one terminal apparatus 100 allocated to the third cluster. The same also applies to the other clusters.

The base station apparatus 200 may allocate only one DL slot among a total of three DL slots including the DL slots #0 to #2 to one terminal apparatus 100. The base station apparatus 200 may allocate at least two DL slots among a total of three DL slots including the DL slots #0 to #2 to one terminal apparatus 100.

### (6) Example of Communication Sequence

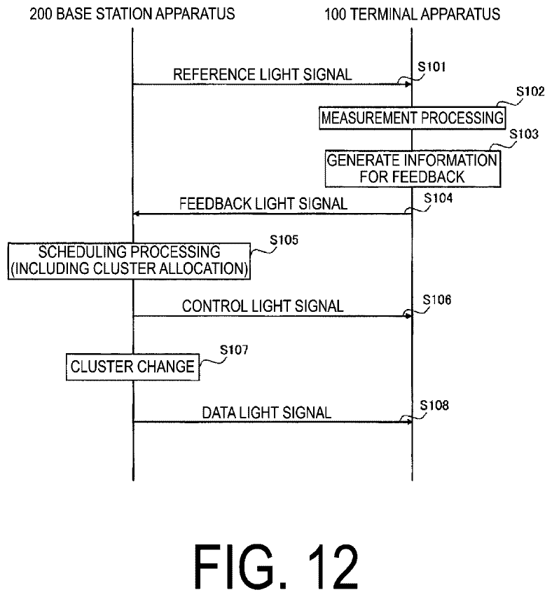

Next, an example of a communication sequence of the optical communication system 1 according to the embodiment will be described. FIG. 12 is a diagram illustrating the example of the communication sequence of the optical communication system 1 according to the embodiment. The order of steps in this sequence is a mere example and may be changed as appropriate.

In step S101, the base station apparatus 200 transmits a reference light signal. The reference light signal is a cluster-specific reference signal and/or a light emitting element-specific reference signal. The terminal apparatus 100 receives the reference light signal from the base station apparatus 200.

In step S102, the terminal apparatus 100 performs measurement processing on the reference light signal received from the base station apparatus 200 in step S101. For example, the terminal apparatus 100 performs channel estimation and/or reception power measurement (which may be reception quality measurement) using the reference light signal received from the base station apparatus 200.

In step S103, the terminal apparatus 100 generates information to be fed back to the base station apparatus 200 based on the result of the measurement processing in step S102. The terminal apparatus 100 may generate measurement information including measurement report information and/or CSI as the feedback information. The measurement information may be measurement information on a per-cluster basis and/or measurement information on a per-light emitting element basis. The terminal apparatus 100 may generate, as the feedback information, information indicating a combination of at least one light emitting element 211 selected by the terminal apparatus 100.

In step S104, the terminal apparatus 100 transmits a feedback light signal including the feedback information generated in step S103 to the base station apparatus 200. The base station apparatus 200 receives the feedback light signal from the terminal apparatus 100.

In step S105, the base station apparatus 200 performs scheduling processing on the terminal apparatus 100 based on the feedback information included in the feedback light signal received from the terminal apparatus 100 in step S104. For example, in the scheduling processing, the base station apparatus 200 determines a time slot to be allocated to the terminal apparatus 100 and a combination of at least one light emitting element 211 constituting a cluster to be allocated to the terminal apparatus 100 in the time slot. In the scheduling processing, the base station apparatus 200 may determine a spreading code to be allocated to the terminal apparatus 100 for data communication.

In step S106, the base station apparatus 200 transmits, to the terminal apparatus 100, a control light signal including scheduling information obtained through the scheduling processing in step S105. The scheduling information may include information indicating the time slot allocated to the terminal apparatus 100. The scheduling information may include information indicating the spreading code allocated to the terminal apparatus 100.

In step S107, the base station apparatus 200 changes the cluster to be allocated to the terminal apparatus 100 in accordance with the combination of the at least one light emitting element 211 determined in step S105.

In step S108, the base station apparatus 200 transmits the same light signals (specifically, data light signals including data addressed to the terminal apparatus 100) from the respective light emitting elements 211 in the cluster allocated to the terminal apparatus 100 in the time slot allocated to the terminal apparatus 100. The terminal apparatus 100 receives and decodes the data light signals from the base station apparatus 200 based on the control light signal received in step S106.

### (7) Configuration Examples of Communication Frame

Next, configuration examples of a communication frame used in the optical communication system 1 according to the embodiment will be described.

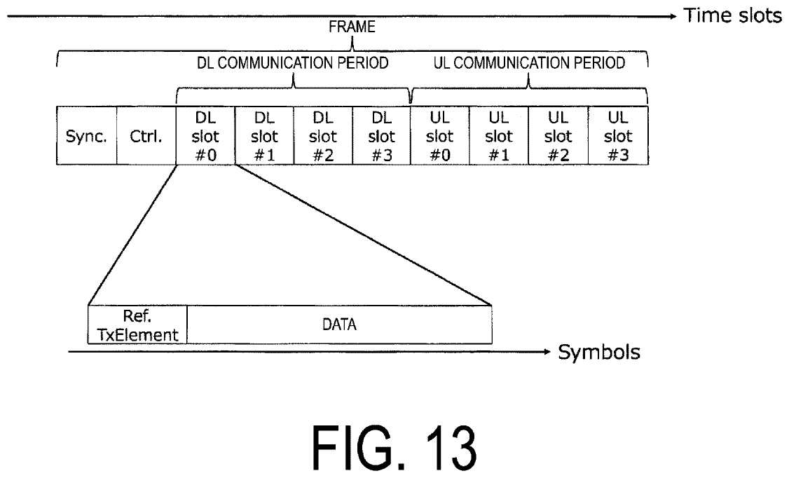

FIG. 13 is a diagram illustrating a first configuration example of the communication frame used in the optical communication system 1 according to the embodiment. Although an example in which one communication frame includes 10 time slots will be described below, the number of time slots constituting one communication frame is not limited to 10. Each time slot includes a predetermined number of symbol sections.

In the first configuration example illustrated in FIG. 13, the communication frame includes one synchronization slot (Sync.), one control slot (Ctrl.), four downlink slots (DL slots) #0 to #3, and four uplink slots (UL slots) #0 to #3. The downlink slots #0 to #3 constitute a downlink communication period. The uplink slots #0 to #3 constitute an uplink communication period.

The synchronization slot (Sync.) is a time slot in which the base station apparatus 200 transmits a synchronization light signal. The terminal apparatus 100 identifies the base station apparatus 200 based on the synchronization light signal received from the base station apparatus 200, and establishes or maintains synchronization by using the synchronization light signal. The control slot (Ctrl.) is a time slot in which the base station apparatus 200 transmits a control light signal.

In the first configuration example, a light emitting element-specific reference signal (Ref.TxElement) and a data light signal are arranged in each downlink slot (DL slot) in a time division manner. In each downlink slot (DL slot), a cluster-specific reference signal may be arranged in addition to or instead of the light emitting element-specific reference signal.

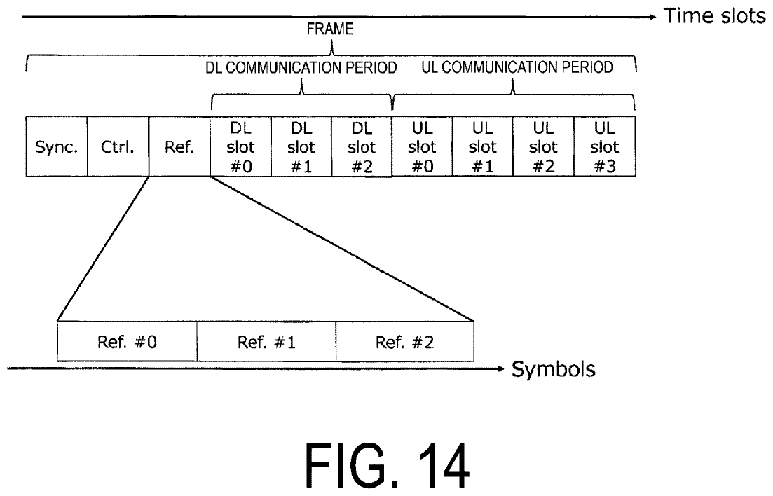

FIG. 14 illustrates a second configuration example of the communication frame used in the optical communication system 1 according to the embodiment.

In the second configuration example illustrated in FIG. 14, the communication frame includes a reference signal slot (Ref.) arranged before a downlink communication period. In the reference signal slot (Ref.), a cluster-specific reference signal of each cluster is arranged in a time division manner.

Here, the number of clusters is three, and three reference signals of Ref. #0 to #2 are arranged in the reference signal slot (Ref.) in a time division manner. That is, the base station apparatus 200 transmits the cluster-specific reference signal of each cluster in the reference signal slot (Ref.) in a time division manner. The terminal apparatus 100 can receive the cluster-specific reference signal of each cluster in the reference signal slot (Ref.) in a time division manner and efficiently perform measurement processing on each cluster-specific reference signal.

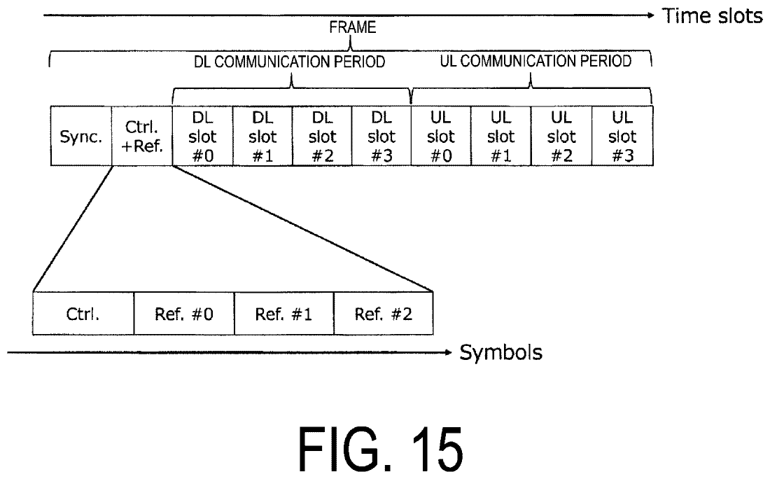

FIG. 15 is a diagram illustrating a third configuration example of the communication frame used in the optical communication system 1 according to the embodiment.

In the third configuration example illustrated in FIG. 15, the communication frame includes one time slot (Ctrl.+Ref.) shared by a control light signal and a cluster-specific reference signal. In the time slot (Ctrl.+Ref.), the control light signal and the cluster-specific reference signal of each cluster are arranged in a time division manner. The base station apparatus 200 transmits the control light signal and the cluster-specific reference signal of each cluster in the time slot (Ctrl.+Ref.) in a time division manner. The terminal apparatus 100 can efficiently receive the control light signal and the cluster-specific reference signal of each cluster in the time slot (Ctrl.+Ref.) in a time division manner.

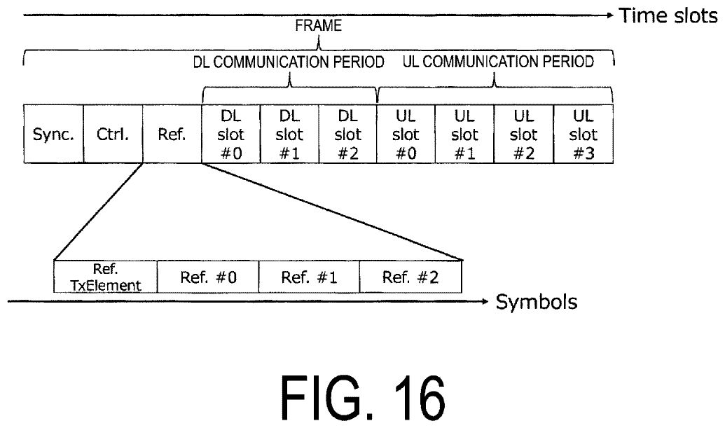

FIG. 16 is a diagram illustrating a fourth configuration example of the communication frame used in the optical communication system 1 according to the embodiment.

In the fourth configuration example illustrated in FIG. 16, the communication frame includes a reference signal slot (Ref.) arranged before a downlink communication period. In the reference signal slot (Ref.), a light emitting element-specific reference signal and a cluster-specific reference signal of each cluster are arranged in a time division manner.

Here, the number of clusters is three, and a light emitting element-specific reference signal (Ref.TxElement) and three reference signals of Ref. #0 to #2 are arranged in the reference signal slot (Ref.) in a time division manner. That is, the base station apparatus 200 transmits the light emitting element-specific reference signal and the cluster-specific reference signal of each cluster in the reference signal slot (Ref.) in a time division manner. The terminal apparatus 100 can efficiently receive the light emitting element-specific reference signal and the cluster-specific reference signal of each cluster in the reference signal slot (Ref.) in a time division manner.

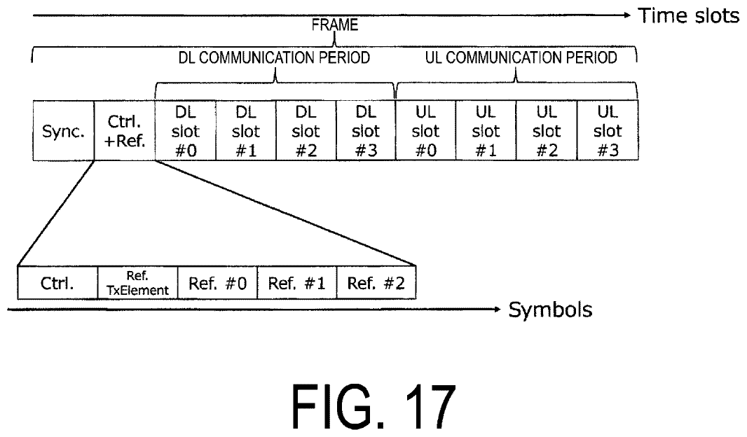

FIG. 17 is a diagram illustrating a fifth configuration example of the communication frame used in the optical communication system 1 according to the embodiment.

In the fifth configuration example illustrated in FIG. 17, the communication frame includes one time slot (Ctrl.+Ref.) shared by a control light signal, a light emitting element-specific reference signal, and cluster-specific reference signals. In the time slot (Ctrl.+Ref.), the control light signal (Ctrl.), the light emitting element-specific reference signal (Ref.TxElement), and the cluster-specific reference signal of each cluster (Ref. #0 to #2) are arranged in a time division manner. The base station apparatus 200 transmits the control light signal, the light emitting element-specific reference signal, and the cluster-specific reference signal of each cluster in the time slot (Ctrl.+Ref.) in a time division manner. The terminal apparatus 100 can efficiently receive the control light signal, the light emitting element-specific reference signal, and the cluster-specific reference signal of each cluster in the time slot (Ctrl.+Ref.) in a time division manner.

### (8) Other Embodiments

In the above-described embodiment, an example in which the base station apparatus 200 causes each cluster to be constituted by light emitting elements 211 adjacent to each other has been described. However, for example, when downlink beamforming or Space Division Multiple Access (SDMA) by Multi Input Multi Output (MIMO) is applied, the base station apparatus 200 may cause each cluster to be constituted by light emitting elements 211 not adjacent to each other.

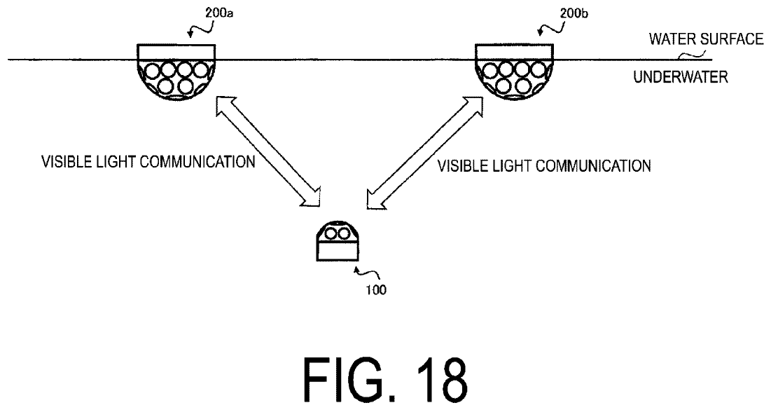

In the above-described embodiment, combined transmission in downlink communication has been mainly described. Specifically, an example in which the base station apparatus 200 performs combined transmission from the respective clusters to the plurality of terminal apparatuses 100 has been described. However, the operation in the above-described embodiment may be performed in uplink communication. A terminal apparatus 100 may perform combined transmission from each cluster to a plurality of base station apparatuses 200. FIG. 18 is a diagram for describing an operation according to another embodiment. As illustrated in FIG. 18, the terminal apparatus 100 simultaneously performs visible light communication with two base station apparatuses 200a and 200b. For example, when handover of the terminal apparatus 100 is performed between the base station apparatuses 200a and 200b, the terminal apparatus 100 simultaneously performs visible light communication with the two base station apparatuses 200a and 200b.

Under such a premise, the terminal apparatus 100 (controller 130) divides a plurality of light emitting elements 111 into a plurality of clusters each of the plurality of clusters being constituted by at least one light emitting element 111. While changing a combination of the at least one light emitting element 111 constituting each cluster in a time division manner, the terminal apparatus 100 (controller 130) transmits the same light signal from the at least one light emitting element 111 in each cluster within each time interval. Each time interval in which the terminal apparatus 100 performs combined transmission is a time interval included in an uplink communication period. The terminal apparatus 100 (the controller 130) allocates the respective clusters to the base station apparatuses 200. For example, the terminal apparatus 100 (controller 130) allocates a first cluster to the base station apparatus 200a and allocates a second cluster to the base station apparatus 200b.

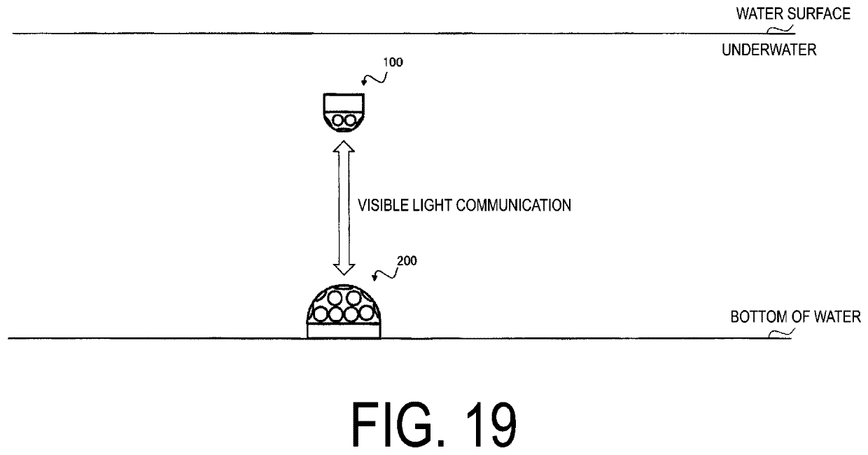

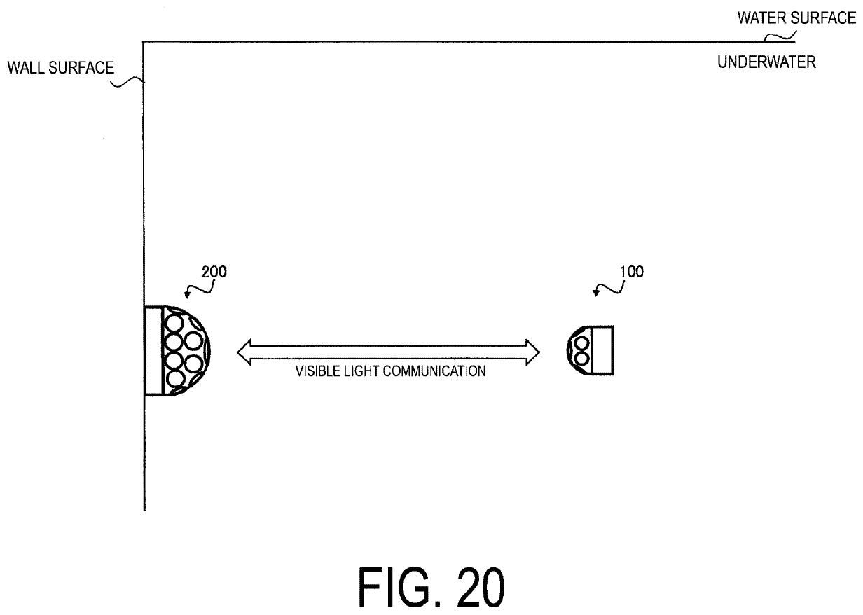

In the above-described embodiment, an example in which the base station apparatus 200 is installed at a water surface has been described. However, as illustrated in FIG. 19, the base station apparatus 200 may be installed at the bottom of water. The terminal apparatus 100 moving underwater performs visible light communication with the base station apparatus 200 located below (diagonally below) the terminal apparatus 100. The base station apparatus 200 may be installed at an underwater wall surface as illustrated in FIG. 20. The terminal apparatus 100, while moving underwater in a vertical direction, performs visible light communication with the base station apparatus 200.

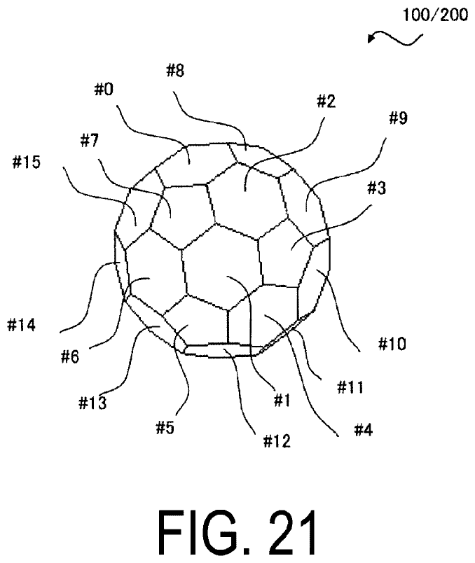

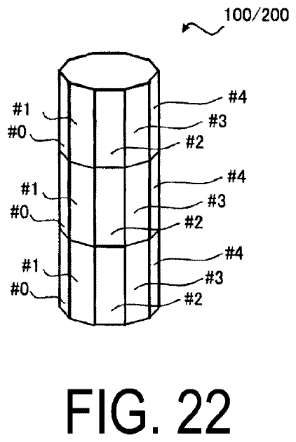

In the above-described embodiment, an example in which the light receiver/emitter 150 of the terminal apparatus 100 and the light receiver/emitter 250 of the base station apparatus 200 each are formed into a hemispherical shape has been described. However, as illustrated in FIG. 21, the terminal apparatus 100 and/or the base station apparatus 200 may be formed into a spherical shape (in another viewpoint, a mirror ball shape) as a whole. For example, the terminal apparatus 100 and/or the base station apparatus 200 may form a polyhedron, each surface of the polyhedron may form a light receiving/emitting region, and a pair of a light emitting element and a light receiving element may be disposed at each surface. As illustrated in FIG. 22, the terminal apparatus 100 and/or the base station apparatus 200 may be formed into a bar shape as a whole. For example, the terminal apparatus 100 and/or the base station apparatus 200 may form a prism, each side surface of the prism may form a light receiving/emitting region, and a pair of a light emitting element and a light receiving element may be disposed at each side surface.

A program that causes a computer to execute each piece of processing performed by the terminal apparatus 100 or the base station apparatus 200 may be provided. The program may be recorded on a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing each piece of processing performed by the terminal apparatus 100 or the base station apparatus 200 may be integrated, and at least a part of the terminal apparatus 100 or the base station apparatus 200 may be configured as a semiconductor integrated circuit (a chipset or an SoC).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

The present application claims priority to Japanese Patent Application No. 2022-086951 (filed on May 27, 2022), the contents of which are incorporated herein by reference in their entirety.

### (9) Supplementary Notes

Features relating to the embodiments described above will be described below as supplement notes.

### Supplementary Note 1

An optical communication apparatus including
a plurality of light emitting elements, and
a controller configured to divide the plurality of light emitting elements into a plurality of clusters, each of the plurality of clusters being constituted by at least one of the plurality of light emitting elements, wherein
the controller is configured to
change a combination of the at least one of the plurality of light emitting elements constituting each of the plurality of clusters in a time division manner and
control the plurality of light emitting elements and causes the at least one of the plurality of light emitting elements in each of the plurality of clusters to transmit the same light signal in an individual time interval.

### Supplementary Note 2

The optical communication apparatus according to supplementary note 1, wherein
the optical communication apparatus is a base station apparatus,
the individual time interval is a time interval included in a downlink communication period, and
the controller is configured to allocate each of the plurality of clusters to at least one terminal apparatus.

### Supplementary Note 3

The optical communication apparatus according to supplementary note 2, further including
a light receiving element configured to receive a feedback light signal from the at least one terminal apparatus, wherein
the controller is configured to determine, based on the feedback light signal, a combination of the at least one of the plurality of light emitting elements constituting each of the plurality of clusters to be allocated to the at least one terminal apparatus.

### Supplementary Note 4

The optical communication apparatus according to supplementary note 3, wherein
the feedback light signal includes information indicating the combination of the at least one of the plurality of light emitting elements selected by the at least one terminal apparatus.

### Supplementary Note 5

The optical communication apparatus according to any of supplementary notes 2 to 4, wherein the controller is configured to multiplex, through code division multiple access, one or more terminal apparatuses to which the same cluster of the plurality of clusters is allocated within one time interval.

### Supplementary Note 6

The optical communication apparatus according to any of supplementary notes 2 to 5, wherein the controller is configured to control the plurality of light emitting elements and causes the at least one of the plurality of light emitting elements in each of the plurality of clusters to transmit a cluster-specific reference signal.

### Supplementary Note 7

The optical communication apparatus according to supplementary note 6, further including
a light receiving element configured to receive a feedback light signal from the at least one terminal apparatus, wherein
the feedback light signal includes measurement information on a per-cluster basis obtained by the at least one terminal apparatus performing measurement processing on the cluster-specific reference signal.

### Supplementary Note 8

The optical communication apparatus according to supplementary note 6 or 7, wherein
the controller is configured to control the plurality of light emitting elements to transmit the cluster-specific reference signal of each of the plurality of clusters in a time division manner within one time interval not included in the downlink communication period.

### Supplementary Note 9

The optical communication apparatus according to any of supplementary notes 2 to 8, wherein the controller is configured to control the plurality of light emitting elements and cause each of the plurality of light emitting elements in each of the plurality of clusters to transmit a light emitting element-specific reference signal.

### Supplementary Note 10

The optical communication apparatus according to supplementary note 9, further including
a light receiving element configured to receive a feedback light signal from the at least one terminal apparatus, wherein
the feedback light signal includes measurement information on a per-light emitting element basis obtained by the terminal apparatus performing measurement processing on the light emitting element-specific reference signal, and
the controller is configured to derive measurement information on a per-cluster basis from the measurement information on a per-light emitting element basis.

### Supplementary Note 11

The optical communication apparatus according to any of supplementary notes 2 to 10, wherein the controller is configured to control the plurality of light emitting elements to transmit a cluster-specific reference signal and a light emitting element-specific reference signal in a time division manner within one time interval not included in the downlink communication period.

### Supplementary Note 12

The optical communication apparatus according to any of supplementary notes 1 to 11, wherein the plurality of light emitting elements are arranged with an angle formed by an optical axis of one of the plurality of light emitting elements and an optical axis of another of the plurality of light emitting elements increasing as a distance between the one of the plurality of light emitting elements and the other of the plurality of light emitting elements increases.

### Supplementary Note 13

The optical communication apparatus according to supplementary note 12, wherein
when one of the plurality of clusters is constituted by at least two of the plurality of light emitting elements, the controller is configured to cause the one of the plurality of clusters to be constituted by light emitting elements adjacent to each other of the at least two of the plurality of light emitting elements.

### Supplementary Note 14

An optical communication method used in an optical communication apparatus including a plurality of light emitting elements, the optical communication method including the steps of:
dividing the plurality of light emitting elements into a plurality of clusters, each of the plurality of clusters being constituted by at least one of the plurality of light emitting elements;
changing a combination of the at least one of the plurality of light emitting elements constituting each of the plurality of clusters in a time division manner; and
controlling the plurality of light emitting elements and causing the at least one of the plurality of light emitting elements in each of the plurality of clusters to transmit the same light signal in an individual time interval.

### Supplementary Note 15

An optical communication program for causing an optical communication apparatus including a plurality of light emitting elements to perform:
dividing the plurality of light emitting elements into a plurality of clusters, each of the plurality of clusters being constituted by at least one of the plurality of light emitting elements;
changing a combination of the at least one of the plurality of light emitting elements constituting each of the plurality of clusters in a time division manner; and controlling the plurality of light emitting elements and causing the at least one of the plurality of light emitting elements in each of the plurality of clusters to transmit the same light signal in an individual time interval.

### REFERENCE SIGNS

1: Optical communication system
100: Terminal apparatus
110: Light emitter
111: Light emitting element
112: Transmitter
120: Light receiver
121: Light receiving element
122: Receiver
130: Controller
131: Processor
132: Memory
150: Light receiver/emitter
151: Light receiving/emitting region
160: Body part
200: Base station apparatus
210: Light emitter
211: Light emitting element
212: Transmitter
220: Light receiver
221: Light receiving element
222: Receiver
230: Controller
231: Processor
232: Memory
240: Backhaul communicator
241: Network communicator
242: Inter-base station communicator
250: Light receiver/emitter
251: Light receiving/emitting region
260: Body part

1. An optical communication apparatus, comprising:
a plurality of light emitting elements; and
a controller configured to divide the plurality of light emitting elements into a plurality of clusters, each of the plurality of clusters being constituted by at least one of the plurality of light emitting elements, wherein
the controller is configured to
change a combination of the at least one of the plurality of light emitting elements constituting each of the plurality of clusters in a time division manner and
control the plurality of light emitting elements and causes the at least one of the plurality of light emitting elements in each of the plurality of clusters to transmit the same light signal in an individual time interval.

2. The optical communication apparatus according to claim 1, wherein
the optical communication apparatus is a base station apparatus,
the individual time interval is a time interval comprised in a downlink communication period, and
the controller is configured to allocate each of the plurality of clusters to at least one terminal apparatus.

3. The optical communication apparatus according to claim 2, further comprising
a light receiving element configured to receive a feedback light signal from the at least one terminal apparatus, wherein
the controller is configured to determine
based on the feedback light signal, a combination of the at least one of the plurality of light emitting elements constituting each of the plurality of clusters to be allocated to the at least one terminal apparatus.

4. The optical communication apparatus according to claim 3, wherein
the feedback light signal comprises information indicating the combination of the at least one of the plurality of light emitting elements selected by the at least one terminal apparatus.

5. The optical communication apparatus according to claim 2, wherein
the controller is configured to multiplex, through code division multiplexing, one or more terminal apparatuses to which the same cluster of the plurality of clusters is allocated within one time interval.

6. The optical communication apparatus according to claim 2, wherein
the controller is configured to control the plurality of light emitting elements and cause the at least one of the plurality of light emitting elements in each of the plurality of clusters to transmit a cluster-specific reference signal.

7. The optical communication apparatus according to claim 6, further comprising
a light receiving element configured to receive a feedback light signal from the at least one terminal apparatus, wherein
the feedback light signal comprises measurement information on a per-cluster basis obtained by the at least one terminal apparatus performing measurement processing on the cluster-specific reference signal.

8. The optical communication apparatus according to claim 6, wherein
the controller is configured to control the plurality of light emitting elements to transmit the cluster-specific reference signal of each of the plurality of clusters in a time division manner within one time interval not included in the downlink communication period.

9. The optical communication apparatus according to claim 2, wherein
the controller is configured to control the plurality of light emitting elements and cause each of the plurality of light emitting elements in each of the plurality of clusters to transmit a light emitting element-specific reference signal.

10. The optical communication apparatus according to claim 9, further comprising
a light receiving element configured to receive a feedback light signal from the at least one terminal apparatus, wherein
the feedback light signal comprises measurement information on a per-light emitting element basis obtained by the at least one terminal apparatus performing measurement processing on the light emitting element-specific reference signal, and
the controller is configured to derive measurement information on a per-cluster basis from the measurement information on a per-light emitting element basis.

11. The optical communication apparatus according to claim 2, wherein
the controller is configured to control the plurality of light emitting elements to transmit a cluster-specific reference signal and a light emitting element-specific reference signal in a time division manner within one time interval not comprised in the downlink communication period.

12. The optical communication apparatus according to claim 1, wherein
the plurality of light emitting elements are arranged with an angle formed by an optical axis of one of the plurality of light emitting elements and an optical axis of another of the plurality of light emitting elements increasing as a distance between the one of the plurality of light emitting elements and the other of the plurality of light emitting elements increases.

13. The optical communication apparatus according to claim 12, wherein
when one of the plurality of clusters is constituted by at least two of the plurality of light emitting elements, the controller is configured to cause the one of the plurality of clusters to be constituted by light emitting elements adjacent to each other of the at least two of the plurality of light emitting elements.

14. An optical communication method to be used in an optical communication apparatus comprising a plurality of light emitting elements, the optical communication method comprising the steps of:
dividing the plurality of light emitting elements into a plurality of clusters, each of the plurality of clusters being constituted by at least one of the plurality of light emitting elements;
changing a combination of the at least one of the plurality of light emitting elements constituting each of the plurality of clusters in a time division manner; and
controlling the plurality of light emitting elements and causing the at least one of the plurality of light emitting elements in each of the plurality of clusters to transmit the same light signal in an individual time interval.

15. An optical communication program for causing an optical communication apparatus comprising a plurality of light emitting elements to perform:
dividing the plurality of light emitting elements into a plurality of clusters, each of the plurality of clusters being constituted by at least one of the plurality of light emitting elements;
changing a combination of the at least one of the plurality of light emitting elements constituting each of the plurality of clusters in a time division manner; and
controlling the plurality of light emitting elements and causing the at least one of the plurality of light emitting elements in each of the plurality of clusters to transmit the same light signal in an individual time interval.
